(19) United States
(12) Patent Application Publication
(10) Pub. No.: US 2026/0180068 A1
(43) Pub. Date: Jun. 25, 2026

(54) BATTERY PACK

(71) Applicants: HYUNDAI MOTOR COMPANY, Seoul (KR); KIA CORPORATION, Seoul (KR)

(72) Inventors: June Ho Lee, Hwaseong-si (KR); Hyun Woo Yoon, Hwaseong-si (KR); Yoon Hyuk Kang, Hwaseong-si (KR); Jun Ho Suh, Hwaseong-si (KR)

(73) Assignees: HYUNDAI MOTOR COMPANY, Seoul (KR); KIA CORPORATION, Seoul (KR)

(21) Appl. No.: 19/244,781

(22) Filed: Jun. 20, 2025

(30) Foreign Application Priority Data
Dec. 20, 2024 (KR) 10-2024-0193263

(51) Int. Cl. H01M 10/6556; H01M 10/613; H01M 10/625; H01M 10/6568; H01M 50/271

(52) U.S. Cl. CPC H01M 10/6556; H01M 10/613; H01M 10/6568; H01M 50/271; H01M 10/625

(57) ABSTRACT

A battery pack is disclosed. The battery pack includes a battery cell, a pack housing that supports the battery cell and includes a base plate having a base channel formed therein through which cooling water flows to cool the battery cell, a cover plate that covers the battery cell and has a cover channel formed therein through which the cooling water flows to cool the battery cell, an inlet pipe that is fluidically connected with the base channel and the cover channel and that supplies the cooling water to the base channel and the cover channel, and an outlet pipe that is fluidically connected with the base channel and the cover channel and that recovers the cooling water from the base channel and the cover channel, and the inlet pipe and the outlet pipe are disposed between the base channel and the cover channel.

### CROSS-REFERENCE TO RELATED APPLICATION(S)

This application claims the benefit of priority to Korean Patent Application No. 10-2024-0193263, filed in the Korean Intellectual Property Office on Dec. 20, 2024, the entire contents of which are incorporated herein by reference.

### TECHNICAL FIELD

The present disclosure relates to a battery pack.

### BACKGROUND

In recent years, research and development on electric vehicles, which are environmentally-friendly vehicles, has been emphasized as crisis awareness of environments and oil resource depletion has increased.

An electric vehicle, which is a vehicle powered by electricity, may include a battery pack. The battery pack may include a base plate for supporting a battery module or a battery cell stack formed of a plurality of battery cells.

It is useful to maintain a predetermined temperature for the performance of the battery cells. A structure may be classified into an air cooling type that adjusts the temperature of the battery cells by circulating air, a direct cooling type that adjusts the temperature of the battery cells using a refrigerant, and a water cooling type that adjusts the temperature of the battery module using water.

In the water cooling type, the cooling performance of the battery cells is deteriorated due to a difference in temperature between the battery cells depending on the positions of where the battery cells are mounted in the battery pack, and therefore it would be useful to address the cooling performance of the battery cells.

### SUMMARY

An aspect of the present disclosure provides a battery pack for reducing a difference in temperature between battery cells depending on the positions where the battery cells are mounted in the battery pack.

The present disclosure provides improvements that may be understood from the following description by those skilled in the art to which the present disclosure pertains.

According to an aspect of the present disclosure, a battery pack includes a battery cell, a pack housing that supports the battery cell and includes a base plate having a base channel through which cooling water flows to cool the battery cell, a cover plate that covers the battery cell and has a cover channel through which cooling water flows to cool the battery cell, an inlet pipe that is fluidically connected with the base channel and the cover channel and that supplies the cooling water to the base channel and the cover channel, and an outlet pipe that is fluidically connected with the base channel and the cover channel and that recovers the cooling water from the base channel and the cover channel, and the inlet pipe and the outlet pipe are disposed between (e.g., heights of) the base channel and the cover channel.

The base channel may include a base inlet fluidically connected with the inlet pipe and a base outlet fluidically connected with the outlet pipe, and the cover channel may include a cover inlet fluidically connected with the inlet pipe and a cover outlet fluidically connected with the outlet pipe. The base outlet may be disposed on a side of the base inlet, and the cover outlet may be disposed on a side of the cover inlet.

The outlet pipe may be disposed on a side of the inlet pipe.

The inlet pipe and the outlet pipe may be disposed outside the pack housing.

The cover plate may include a plate body area and a plate protrusion area that covers the inlet pipe and the outlet pipe and protrudes from the plate body area.

The cover channel may include a cover inlet fluidically connected with the inlet pipe, a first inlet protrusion passage that is fluidically connected with the cover inlet and that extends on the plate protrusion area in a lengthwise direction of the plate protrusion area, and a second inlet protrusion passage that extends from the first inlet protrusion passage in a direction crossing the lengthwise direction of the plate protrusion area.

The battery pack may further include a bracket plate that is coupled to the cover plate and forms the first inlet protrusion passage and the second inlet protrusion passage with the cover plate.

The bracket plate may extend in the lengthwise direction of the plate protrusion area and may extend in the direction crossing the lengthwise direction of the plate protrusion area.

The cover channel may include a cover outlet fluidically connected with the outlet pipe and an outlet protrusion passage that is fluidically connected with the cover outlet and that extends on the plate protrusion area in a lengthwise direction of the plate protrusion area.

The pack housing may further include a pair of side members that cover opposite sides of the battery cell, an end member connected to the pair of side members, and a protruding support member that protrudes from the end member and supports the plate protrusion area.

The battery pack may further include a plate sealing member that extends along a periphery of the plate protrusion area and seals a space between the plate protrusion area and the protruding support member.

The cover channel may include a cover inlet fluidically connected with the inlet pipe and a cover outlet fluidically connected with the outlet pipe. The protruding support member may include a first fluid connection opening fluidically connected with the cover inlet and a second fluid connection opening fluidically connected with the cover outlet. The battery pack may further include a first cover sealing member disposed around the first fluid connection opening to seal a space between the cover inlet and the first fluid connection opening and a second cover sealing member disposed around the second fluid connection opening to seal a space between the cover outlet and the second fluid connection opening.

The battery pack may further include a pack cover that covers the cover plate and supported by the pack housing, and the pack cover may include a cover body area that is coupled to the pack housing and that covers the plate body area and a cover protrusion area that protrudes from the cover body area and covers the plate protrusion area.

The battery pack may further include a busbar electrically connected to the battery cell and a connector that is electrically connected to the busbar and that protrudes from the cover body area to an opposite side of the battery cell, and the pack cover may cover the connector.

The base plate may include a base body area configured to contact the battery cell and a base protrusion area that protrudes from the base body area and covers the inlet pipe and the outlet pipe.

The inlet pipe may include an inlet pipe portion and an inlet fluid connection pipe portion that extends in a direction crossing the inlet pipe portion and fluidically connects the inlet pipe portion, the base inlet, and the cover inlet.

The battery pack may further include an inlet sealing member disposed around the inlet fluid connection pipe portion.

The outlet pipe may include an outlet pipe portion and an outlet fluid connection pipe portion that extends in a direction crossing the outlet pipe portion and fluidically connects the outlet pipe portion, the base outlet, and the cover outlet.

The battery pack may further include an outlet sealing member disposed around the outlet fluid connection pipe portion.

The battery pack may further include a housing sealing member that extends along a periphery of the pack housing and seals a space between the pack housing and the cover plate.

### BRIEF DESCRIPTION OF THE DRAWINGS

The present disclosure will be more apparent from the following detailed description taken in conjunction with the accompanying drawings:

FIG. 1 is a perspective view illustrating a state in which a pack cover of a battery pack is separated from a pack housing according to an example embodiment of the present disclosure;

FIG. 2 is a perspective view illustrating a state in which a cover plate of the battery pack is separated from the pack housing according to an example embodiment of the present disclosure;

FIG. 3 is an enlarged perspective view of a front part of the battery pack according to an example embodiment of the present disclosure;

FIG. 4 is an enlarged perspective view of the front part of the battery pack illustrated in FIG. 3 as viewed from below;

FIG. 5 is an enlarged perspective view of front parts of the cover plate and the pack housing according to an example embodiment of the present disclosure;

FIG. 6 is an enlarged perspective view of the cover plate and a bracket plate according to an example embodiment of the present disclosure;

FIG. 7 is a view illustrating a base channel of a base plate according to an example embodiment of the present disclosure;

FIG. 8 is a view illustrating a cover channel of the cover plate according to an example embodiment of the present disclosure;

FIG. 9 is a vertical sectional view taken along line A-A illustrated in FIG. 5;

FIG. 10 is a vertical sectional view taken along line B-B illustrated in FIG. 5; and

FIG. 11 is an enlarged perspective view of a protruding support member and a front part of the pack housing according to an example embodiment of the present disclosure.

### DETAILED DESCRIPTION

Hereinafter, some example embodiments of the present disclosure will be described in detail with reference to the exemplary drawings. In adding the reference numerals to the components of each drawing, it should be noted that the identical or equivalent component is designated by the same numeral even when they are displayed on other drawings. Further, in describing the example embodiment of the present disclosure, a detailed description of known features or functions may be omitted in order not to unnecessarily obscuring the present disclosure.

In describing the components of the example embodiment according to the present disclosure, terms such as first, second, “A”, “B”, (a), (b), and the like may be used. These terms are intended to distinguish one component from another component, and the terms do not limit the nature, sequence or order of the components. Unless otherwise provided, terms used herein, including technical or scientific terms, have the same meanings as those generally understood by those skilled in the art to which the present disclosure pertains. Such terms as those provided in a generally used dictionary are to be interpreted as having meanings the same or similar to the contextual meanings in the relevant field of art, and are not to be interpreted as having excessively formal meanings unless provided as having such in the present application.

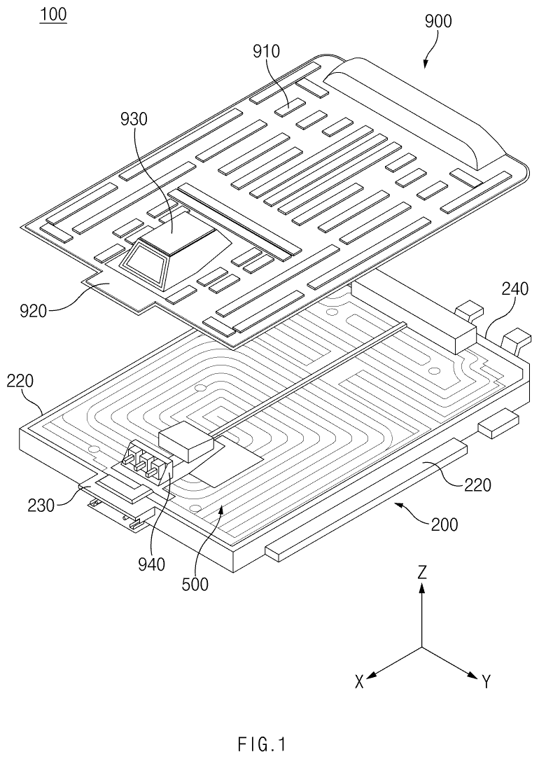

Hereinafter, example embodiments of the present disclosure is described with reference to FIGS. 1 to 11. Hereinafter, a first direction may be an X direction (a front direction) or a direction opposite to the X direction (a rear direction), a second direction may be a Y direction (a left direction) or a direction opposite to the Y direction (a right direction), and a third direction may be a Z direction (an upper direction) or a direction opposite to the Z direction (a lower direction). Here, the first direction may be an overall-length direction of an electric vehicle, and the second direction may be a width direction of the electric vehicle.

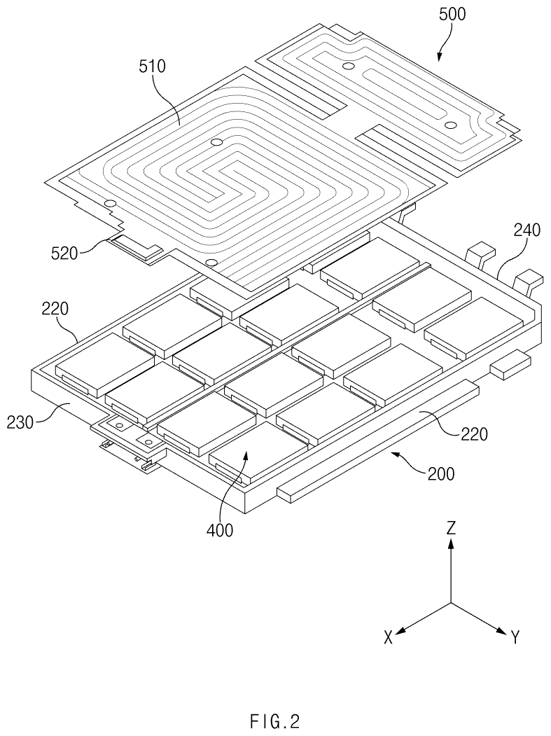

FIG. 1 is a perspective view illustrating a state in which a pack cover of a battery pack is separated from a pack housing according to an example embodiment of the present disclosure. FIG. 2 is a perspective view illustrating a state in which a cover plate of the battery pack is separated from the pack housing according to an example embodiment of the present disclosure.

Referring to FIGS. 1 and 2, the battery pack 100 may include the pack housing 200, a battery module 400 mounted in the pack housing 200, the cover plate 500 located on one side (e.g., a side) of the battery module 400 in the third direction (in the Z direction), and the pack cover 900 located on one side (e.g., a side) of the cover plate 500 in the third direction (in the Z direction).

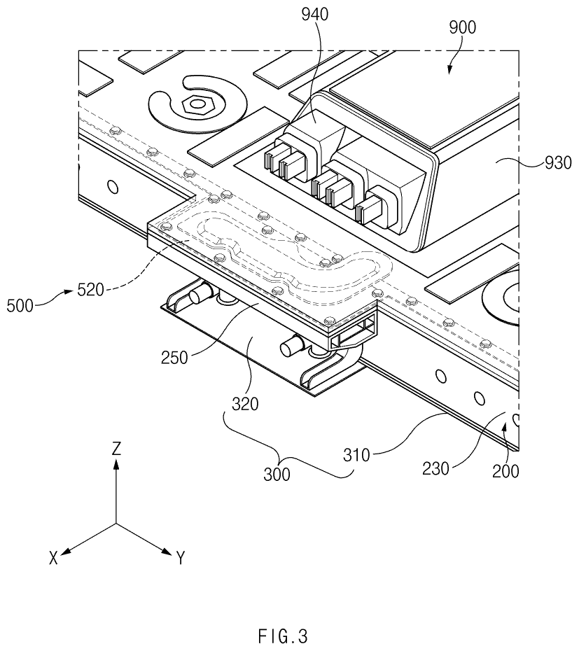

The pack housing 200 may include a base plate 300 (refer to FIG. 3), and a pair of side members 220, a front member 230, and a rear member 240 that are coupled to the base plate 300.

The pair of side members 220 may be coupled to opposite areas of the base plate 300 in the second direction (in the Y direction or the direction opposite to the Y direction). The side members 220 may cover opposite sides of the battery module 400 in the second direction (in the Y direction or the direction opposite to the Y direction).

The front member 230 and the rear member 240 may be referred to as end members. The end members may be connected to the pair of side members 220. The front member 230 may cover one side of the battery module 400 in the first direction (in the X direction). The rear member 240 may cover an opposite side of the battery module 400 in the first direction (in the direction opposite to the X direction).

The cover plate 500 may cover one side (e.g., a side) of the battery module 400 in the third direction (in the Z direction) and may cool battery cells belonging to the battery module 400. Cooling water may flow inside the cover plate 500.

The cover plate 500 may include a plate body area 510 and a plate protrusion area 520. The plate body area 510 may be provided on one side of the battery module 400 in the third direction (in the Z direction). The plate protrusion area 520 may protrude from the plate body area 510 to one side in the first direction (in the X direction).

The pack cover 900 may cover one side of the cover plate 500 in the third direction (in the Z direction) and may be supported by the pack housing 200. The pack cover 900 may include a cover body area 910, a cover protrusion area 920, and a connector cover area 930.

The cover body area 910 may be coupled to the pack housing 200 and may cover the plate body area 510. The cover protrusion area 920 may protrude from the cover body area 910 (e.g., to one side) in the first direction (in the X direction). The cover protrusion area 920 may cover the plate protrusion area 520.

The connector cover area 930 may protrude from the cover body area 910 to one side in the third direction (in the Z direction). The connector cover area 930 may cover a connector 940 of the battery pack 100.

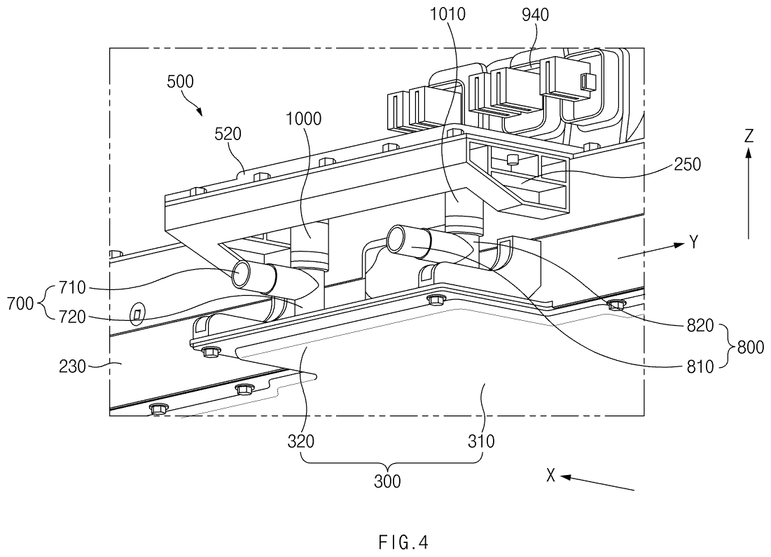

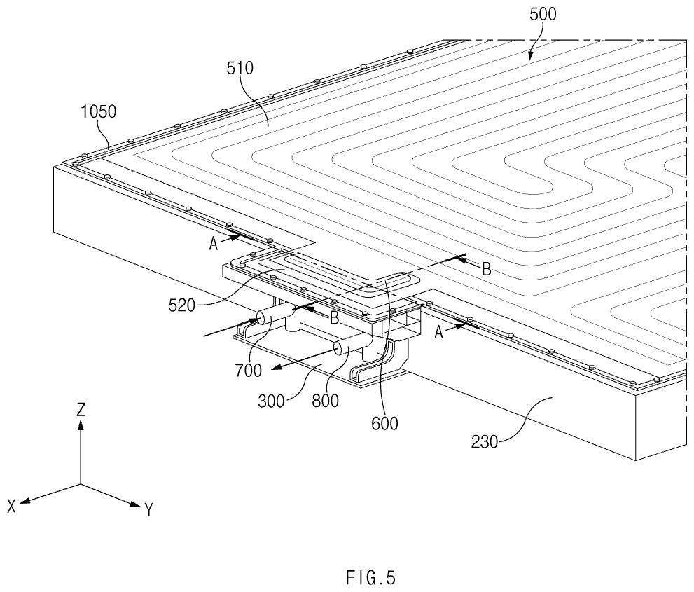

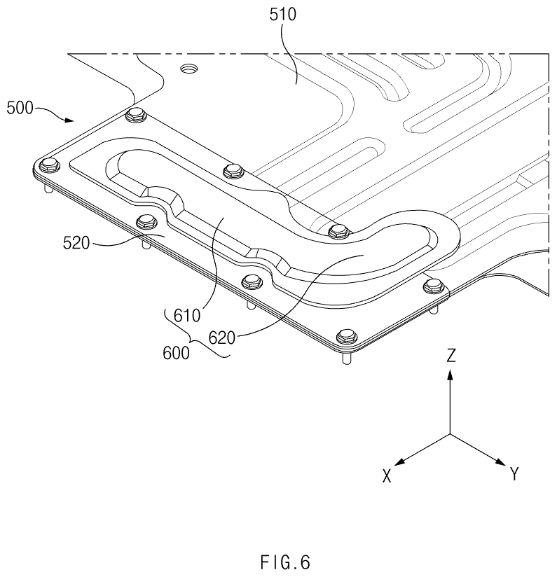

FIG. 3 is an enlarged perspective view of a front part of the battery pack according to an example embodiment of the present disclosure. FIG. 4 is an enlarged perspective view of the front part of the battery pack illustrated in FIG. 3 as viewed from below. FIG. 5 is an enlarged perspective view of front parts of the cover plate and the pack housing according to an example embodiment of the present disclosure. FIG. 6 is an enlarged perspective view of the cover plate and a bracket plate according to an example embodiment of the present disclosure.

Referring to FIGS. 3 to 6, the pack housing 200 of the battery pack 100 (refer to FIG. 1) may include a protruding support member 250 that supports the plate protrusion area 520 and protrudes from the front member 230 to one side in the first direction (in the X direction). The protruding support member 250 may be coupled to the front member 230.

The base plate 300 may include a base body area 310 and a base protrusion area 320. The base body area 310 may (e.g., be brought into) contact (e.g., with) the battery cells of the battery module 400 (refer to FIG. 2) and may support the battery cells. The base protrusion area 320 may protrude from the base body area 310 to one side in the first direction (in the X direction).

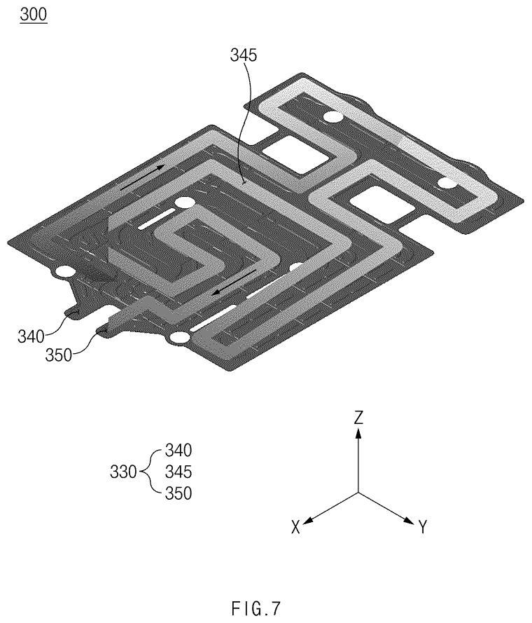

Cooling water for cooling the battery cells may flow inside the base plate 300. The base plate 300 may have a base channel 330 (refer to FIG. 7) formed therein through which the cooling water for cooling the battery cells flows.

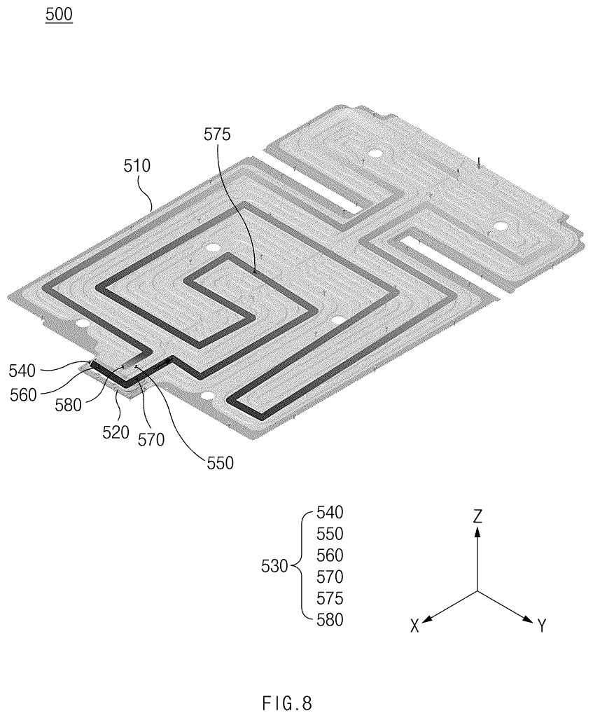

Similar to the base plate 300, the cover plate 500 may have a cover channel 530 (refer to FIG. 8) formed therein through which cooling water for cooling the battery cells flows. The base plate 300 and the cover plate 500 may be disposed on opposite sides of the battery cells in the third direction (in the Z direction or the direction opposite to the Z direction) and may cool the opposite sides of the battery cells.

The battery pack 100 may include an inlet pipe 700 that is fluidically connected with the base channel 330 and the cover channel 530 and that supplies cooling water to the base channel 330 and the cover channel 530 and an outlet pipe 800 that is fluidically connected with the base channel 330 and the cover channel 530 and that recovers the cooling water from the base channel 330 and the cover channel 530.

The inlet pipe 700 and the outlet pipe 800 may be disposed between the height of the base channel 330 and the cover channel 530 in the third direction. The inlet pipe 700 and the outlet pipe 800 may be spaced apart from each other in the second direction. The outlet pipe 800 may be disposed on one side of the inlet pipe 700 in the second direction (in the Y direction). The inlet pipe 700 and the outlet pipe 800 may be disposed outside the pack housing 200. The inlet pipe 700 and the outlet pipe 800 may extend toward the front member 230 and may extend to opposite sides in the third direction (in the Z direction or the direction opposite to the Z direction).

The inlet pipe 700 may include an inlet pipe portion 710 extending toward the pack housing 200 and an inlet fluid connection pipe portion 720 extending in a direction crossing the inlet pipe portion 710. The inlet fluid connection pipe portion 720 may fluidically connect the inlet pipe portion 710 and the base channel 330 and may fluidically connect the inlet pipe portion 710 and the cover channel 530.

The outlet pipe 800 may include an outlet pipe portion 810 extending toward the pack housing 200 and an outlet fluid connection pipe portion 820 extending in a direction crossing the outlet pipe portion 810. The outlet fluid connection pipe portion 820 may fluidically connect the outlet pipe portion 810 and the base channel 330 and may fluidically connect the outlet pipe portion 810 and the cover channel 530.

The inlet pipe 700 and the outlet pipe 800 may be disposed between the base protrusion area 320 and the plate protrusion area 520. The base protrusion area 320 may cover an opposite side of the inlet pipe 700 and the outlet pipe 800 that faces in the third direction (in the direction opposite to the Z direction). The plate protrusion area 520 may cover one side of the inlet pipe 700 and the outlet pipe 800 that faces in the third direction (in the Z direction).

Since the inlet pipe 700 and the outlet pipe 800 are located on one side of the battery pack 100 in the first direction (in the X direction), the connector 940 of the battery pack 100 may protrude to one side in the third direction (in the Z direction) as compared to the cover body area 910. Since the connector 940 is electrically connected to a busbar and electrically connected to the battery cells, the connector 940 may protrude to the opposite side to the battery cells as compared to the cover body area 910 and may be exposed outside the battery pack 100. One surface of the connector 940 may be exposed outside the battery pack 100, but the remaining surfaces of the connector 940 may be covered by the pack cover 900.

The battery pack 100 may further include the bracket plate 600 coupled to the cover plate 500. The bracket plate 600, together with the cover plate 500, may form a portion of the cover channel 530.

The bracket plate 600 may extend in the lengthwise direction of the plate protrusion area 520 and may extend in a direction crossing the lengthwise direction of the plate protrusion area 520. The bracket plate 600 may extend in the second direction (in the Y direction or the direction opposite to the Y direction) and may extend to an opposite side in the first direction (in the direction opposite to the X direction).

The bracket plate 600 may include a first bracket area 610 and a second bracket area 620. The first bracket area 610 may be a portion of the bracket plate 600 that extends in the second direction (in the Y direction or the direction opposite to the Y direction). The second bracket area 620 may be a portion of the bracket plate 600 that extends in the first direction (in the X direction or the direction opposite to the X direction). The bracket plate 600 may be formed in the shape of “L”.

If the flow direction of the cooling water flowing through the base channel 330 is the same as the flow direction of the cooling water flowing through the cover channel 530 when the opposite sides of the battery cells are cooled, there may be a difference in cooling performance between the battery cells depending on the position deviation in the width direction of the battery pack 100 (refer to FIG. 1).

To reduce the cooling performance difference described above, the flow directions of the cooling water flowing through the cover channel 530 and the base channel 330 of the battery pack 100 according to an example embodiment of the present disclosure may be opposite to each other. The base channel 330 and the cover channel 530 are described hereinafter.

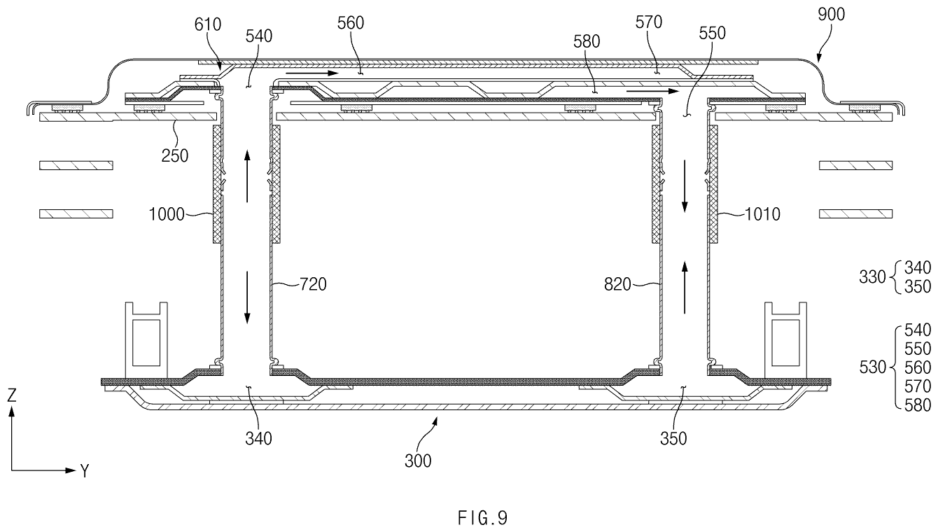

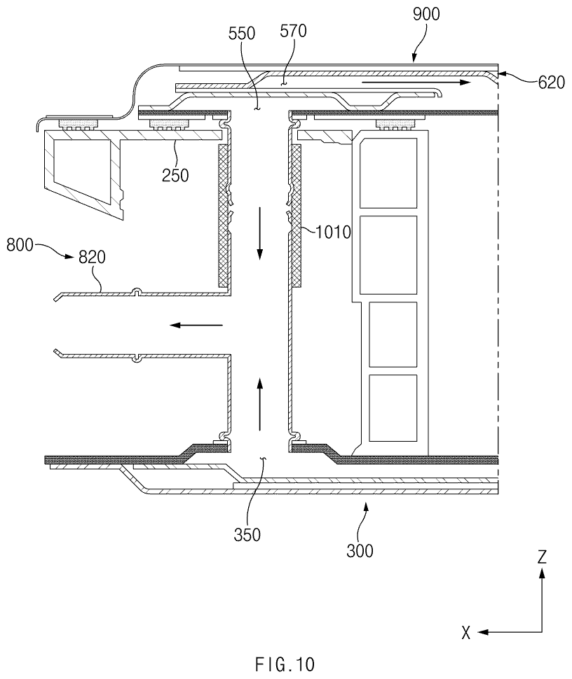

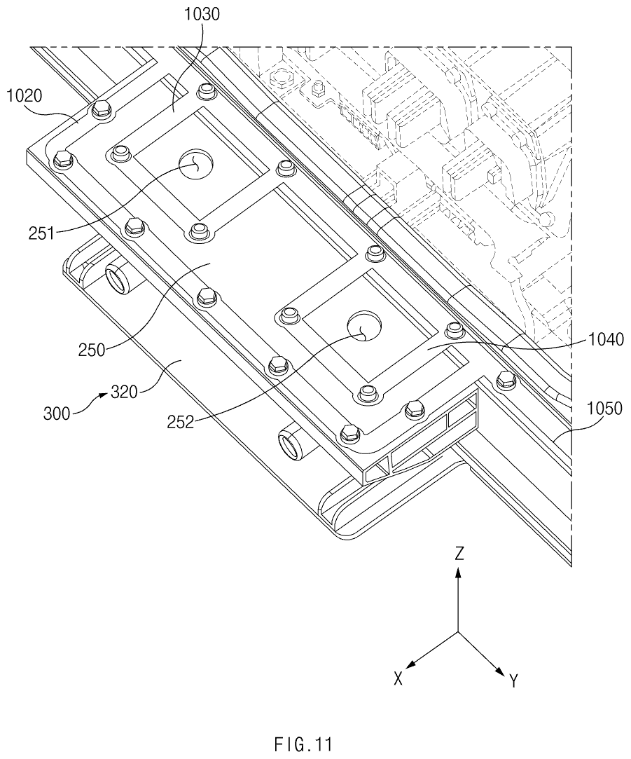

FIG. 7 is a view illustrating the base channel of the base plate according to an example embodiment of the present disclosure. FIG. 8 is a view illustrating the cover channel of the cover plate according to an example embodiment of the present disclosure. FIG. 9 is a vertical sectional view taken along line A-A illustrated in FIG. 5. FIG. 10 is a vertical sectional view taken along line B-B illustrated in FIG. 5. FIG. 11 is an enlarged perspective view of the protruding support member and the front part of the pack housing according to an example embodiment of the present disclosure.

Referring to FIGS. 7 to 11, the base plate 300 may include a base inlet 340, a base outlet 350, and a base fluid connection passage 345 located between the base inlet 340 and the base outlet 350, and the base inlet 340 and the base outlet 350 may be formed on one area (e.g., an area) that faces in the first direction (in the X direction).

The base inlet 340 may be disposed on an opposite side of the base outlet 350 in the second direction (in the direction opposite to the Y direction), and cooling water introduced through the base inlet 340 may flow through the base fluid connection passage 345 inside the base plate 300 and may be discharged to the outside of the base plate 300 through the base outlet 350.

The cooling water flowing through the base channel 330 may flow to an opposite side in the first direction (in the direction opposite to the X direction) through the base inlet 340 and then may flow to one side in the first direction (in the X direction) through the base outlet 350.

The cover plate 500 may include a cover inlet 540, a cover outlet 550, and a cover fluid connection passage 575 located between the cover inlet 540 and the cover outlet 550, and the cover inlet 540 and the cover outlet 550 may be formed on one area that faces in the first direction (in the X direction).

The cover inlet 540 may be disposed on an opposite side of the cover outlet 550 in the second direction (in the direction opposite to the Y direction), and cooling water introduced through the cover inlet 540 may flow through the cover fluid connection passage 575 inside the cover plate 500 and may be discharged to the outside of the cover plate 500 through the cover outlet 550.

The cover plate 500 may include a first inlet protrusion passage 560 that is fluidically connected with the cover inlet 540 and that extends on the plate protrusion area 520 in the lengthwise direction of the plate protrusion area 520 and a second inlet protrusion passage 570 that extends from the first inlet protrusion passage 560 in a direction crossing the lengthwise direction of the plate protrusion area 520.

The first inlet protrusion passage 560 may be provided (e.g., defined) by the first bracket area 610 and the cover plate 500. The second inlet protrusion passage 570 may be provided (e.g., defined) by the second bracket area 620 and the cover plate 500.

The first and second inlet protrusion passages 560 and 570, which are portions formed between the cover plate 500 and the bracket plate 600, may be formed by the cover plate 500 and the bracket plate 600.

The cover plate 500 may include an outlet protrusion passage 580 that is fluidically connected with the cover outlet 550 and that extends on the plate protrusion area 520 in the lengthwise direction of the plate protrusion area 520.

The outlet protrusion passage 580 may be formed on the opposite side in the third direction (in the direction opposite to the Z direction) as compared to the first and second outlet protrusion passages 560 and 570.

In this structure, unlike the cooling water flowing through the base channel 330, the cooling water flowing through the cover channel 530 may flow to one side in the second direction (in the Y direction) through the cover inlet 540 and the first inlet protrusion passage 560 and then may flow to the opposite side in the first direction (in the direction opposite to the X direction) through the second inlet protrusion passage 570.

The cooling water flowing to the opposite side in the first direction (in the direction opposite to the X direction) through the second inlet protrusion passage 570 may flow through the cover fluid connection passage 575, may flow to one side in the second direction (in the Y direction) through the outlet protrusion passage 580, and may be discharged through the cover outlet 550.

With respect to the flow direction of the cooling water flowing through the base channel 330, an opposite area of the base plate 300 that faces in the second direction (in the direction opposite to the Y direction) may be located upstream of one area of the base plate 300 that faces in the second direction (in the Y direction).

In contrast, with respect to the flow direction of the cooling water flowing through the cover channel 530, one area of the cover plate 500 that faces in the second direction (in the Y direction) may be located upstream of an opposite area of the base plate 500 that faces in the second direction (in direction opposite to the Y direction).

Accordingly, the temperature of the opposite area of the base plate 300 that faces in the second direction (in the direction opposite to the Y direction) may be lower than the temperature of the one area of the base plate 300 that faces in the second direction (in the Y direction)

In contrast, the temperature of the one area of the cover plate 500 that faces in the second direction (in the Y direction) may be lower than the temperature of the opposite area of the base plate 500 that faces in the second direction (in direction opposite to the Y direction).

Accordingly, the difference in cooling performance between the battery cells depending on position deviation in the second direction (the Y direction or the direction opposite to the Y direction), which is the width direction of the battery pack 100 (refer to FIG. 1), may be reduced, and thus the cooling performance of the battery cells may be improved.

The base inlet 340 may be fluidically connected with the inlet pipe 700 (refer to FIG. 5), and the base outlet 350 may be fluidically connected with the outlet pipe 800. The cover inlet 540 may be fluidically connected with the inlet pipe 700, and the cover outlet 550 may be fluidically connected with the outlet pipe 800.

The base outlet 350 may be disposed on one side of the base inlet 340 in the second direction (in the Y direction), and the cover outlet 550 may be disposed on one side of the cover inlet 540 in the second direction (in the Y direction).

The base outlet 350 is disposed on the one side of the base inlet 340 in the second direction (in the Y direction) and the cover outlet 550 is disposed on the one side of the cover inlet 540 in the second direction (in the Y direction), because the base outlet 350 and the cover outlet 550 may be (e.g., have to be) disposed adjacent to the outlet pipe 800 and fluidically connected with the outlet pipe 800 and the base inlet 340 and the cover inlet 540 may be (e.g., have to be) disposed adjacent to the inlet pipe 700 and fluidically connected with the inlet pipe 700.

In addition, the inlet fluid connection pipe portion 720 may fluidically connect the inlet pipe portion 710, the base inlet 340, and the cover inlet 540, and the outlet fluid connection pipe portion 820 may fluidically connect the outlet pipe portion 810, the base outlet 350, and the cover outlet 550.

In this case, unlike the structure in which the inlet fluid connection pipe portion 720 is (e.g., directly) connected to the base plate 300, the inlet fluid connection pipe portion 720 is connected to the cover plate 500 through the protruding support member 250, and therefore the space between the inlet fluid connection pipe portion 720 and the protruding support member 250 may be (e.g., needs to be) sealed.

Accordingly, the battery pack 100 may include an inlet sealing member 1000 disposed around the inlet fluid connection pipe portion 720 to surround the inlet fluid connection pipe portion 720 and an outlet sealing member 1010 disposed around the outlet fluid connection pipe portion 820 to surround the outlet fluid connection pipe portion 820.

The inlet sealing member 1000 may surround an area of the inlet fluid connection pipe portion 720 adjacent to the protruding support member 250 to seal the space between the protruding support member 250 and the inlet fluid connection pipe portion 720.

The outlet sealing member 1010 may surround an area of the outlet fluid connection pipe portion 820 adjacent to the protruding support member 250 to seal the space between the protruding support member 250 and the outlet fluid connection pipe portion 820.

The inlet sealing member 1000 and the outlet sealing member 1010 may be formed of an elastic member (e.g., rubber). In this structure, the cooling water flowing through the inlet fluid connection pipe portion 720 or the outlet fluid connection pipe portion 820 may be prevented from leaking through the space between the protruding support member 250 and the inlet fluid connection pipe portion 720 or the space between the protruding support member 250 and the outlet fluid connection pipe portion 820. Accordingly, the safety of the battery pack 100 may be improved, and the cooling performance of the battery pack 100 may be prevented from deteriorating.

The protruding support member 250 may include first and second fluid connection holes (e.g., openings) 251 and 252 formed in one surface brought into contact with the cover plate 500. The first fluid connection hole 251 may be fluidically connected with the cover inlet 540. The second fluid connection hole 252 may be fluidically connected with the cover outlet 550.

The second fluid connection hole 252 may be disposed on one side in the second direction (in the Y direction) as compared to the first fluid connection hole 251. The first fluid connection hole 251 may be a portion connected with the inlet fluid connection pipe portion 720, and the second fluid connection hole 252 may be a portion connected with the outlet fluid connection pipe portion 820.

The battery pack 100 (refer to FIG. 1) may include a first cover sealing member 1030 disposed around the first fluid connection hole 251 to seal the space between the cover inlet 540 and the first fluid connection hole 251 and a second cover sealing member 1040 disposed around the second fluid connection hole 252 to seal the space between the cover outlet 550 and the second fluid connection hole 252.

The first cover sealing member 1030 and the second cover sealing member 1040 may be coupled (e.g., fixed) to one surface of the protruding support member 250 that is brought into contact with the plate protrusion area 520.

In addition, the battery pack 100 may further include a plate sealing member 1020 extending along the periphery of the plate protrusion area 520 to seal the space between the protruding support member 250 and the plate protrusion area 520.

The plate sealing member 1020 may be coupled (e.g., fixed) to the one surface of the protruding support member 250 that is brought into contact with the plate protrusion area 520.

The first cover sealing member 1030, the second cover sealing member 1040, and the plate sealing member 1020 may be formed of an elastic member (e.g., rubber). The first cover sealing member 1030 and the second cover sealing member 1040 may (e.g., firstly) seal the space between the plate protrusion area 520 and the protruding support member 250, and the plate sealing member 1020 may (e.g., secondly) seal the space between the plate protrusion area 520 and the protruding support member 250.

In this structure, the first cover sealing member 1030 may prevent the cooling water from leaking through the space between the first fluid connection hole 251 and the cover inlet 540, and the second cover sealing member 1040 may prevent the cooling water from leaking through the space between the second fluid connection hole 252 and the cover outlet 550. Accordingly, the safety of the battery pack 100 may be improved, and the cooling performance of the battery pack 100 may be prevented from deteriorating.

In addition, the battery pack 100 may include a housing sealing member 1050 that extends along the periphery of the pack housing 200 and seals the space between the pack housing 200 and the cover plate 500.

The housing sealing member 1050 may extend along the side members 220 (refer to FIG. 1), the front member 230, and the rear member 240 and may be coupled (e.g., fixed) to the side members 220, the front member 230, and the rear member 240.

The housing sealing member 1050 may be formed of an elastic member (e.g., rubber). The housing sealing member 1050 is provided so that the cover plate 500 as well as the base plate 300 is provided to cool the battery cells of the battery pack 100 according to an example embodiment of the present disclosure.

The plate sealing member 1020, the first cover sealing member 1030, the second cover sealing member 1040, and the housing sealing member 1050 may be integrally formed, or may be formed as separate components.

In this structure, the housing sealing member 1050 may prevent the cooling water from leaking through the space between the pack housing 200 and the cover plate 500. Accordingly, the safety of the battery pack 100 may be improved, and the cooling performance of the battery pack 100 may be prevented from deteriorating.

The present disclosure may reduce the temperature difference between the battery cells depending on the positions of where the battery cells are mounted in the battery pack, thereby improving the cooling performance of the battery cells.

Further, the present disclosure may seal the space between the cover plate and the protruding support member, thereby preventing the cooling water from leaking and improving the safety of the battery pack.

Furthermore, the present disclosure may seal the space between the cover plate and the pack housing, thereby preventing the cooling water from leaking and improving the safety of the battery pack.

Moreover, the present disclosure may seal the space between the inlet pipe, the outlet pipe, and the protruding support member, thereby preventing the cooling water from leaking and improving the safety of the battery pack.

In addition, the present disclosure may provide various improvements that are directly or indirectly recognized.

Hereinabove, although the present disclosure has been described with reference to exemplary example embodiments and the accompanying drawings, the present disclosure is not limited thereto, but may be modified and altered by those skilled in the art to which the present disclosure pertains without departing from the present disclosure.

Therefore, the example embodiments of the present disclosure are provided to explain the present disclosure, but not to limit them, so that the present disclosure is not limited by the example embodiments. The scope of the present disclosure should be construed on the basis of the accompanying claims, and the technical ideas within the scope equivalent to the claims should be included in the scope of the present disclosure.

What is claimed is:

1. A battery pack comprising:
a battery cell;
a pack housing configured to support the battery cell, the pack housing including a base plate having a base channel through which cooling water flows to cool the battery cell;
a cover plate configured to cover the battery cell, the cover plate having a cover channel through which cooling water flows to cool the battery cell;
an inlet pipe fluidically connected with the base channel and the cover channel, and the inlet pipe is configured to supply the cooling water to the base channel and the cover channel; and
an outlet pipe fluidically connected with the base channel and the cover channel, and the outlet pipe is configured to recover the cooling water from the base channel and the cover channel,
wherein the inlet pipe and the outlet pipe are disposed between the base channel and the cover channel.

2. The battery pack of claim 1, wherein the base channel includes a base inlet fluidically connected with the inlet pipe and a base outlet fluidically connected with the outlet pipe,
wherein the cover channel includes a cover inlet fluidically connected with the inlet pipe and a cover outlet fluidically connected with the outlet pipe, and
wherein the base outlet is disposed on a side of the base inlet, and the cover outlet is disposed on a side of the cover inlet.

3. The battery pack of claim 2, wherein the outlet pipe is disposed on a side of the inlet pipe.

4. The battery pack of claim 1, wherein the inlet pipe and the outlet pipe are disposed outside the pack housing.

5. The battery pack of claim 1, wherein the cover plate includes:
a plate body area; and
a plate protrusion area configured to cover the inlet pipe and the outlet pipe and protrude from the plate body area.

6. The battery pack of claim 5, wherein the cover channel includes:
a cover inlet fluidically connected with the inlet pipe;
a first inlet protrusion passage fluidically connected with the cover inlet and configured to extend on the plate protrusion area in a lengthwise direction of the plate protrusion area; and
a second inlet protrusion passage configured to extend from the first inlet protrusion passage in a direction crossing the lengthwise direction of the plate protrusion area.

7. The battery pack of claim 6, further comprising:
a bracket plate coupled to the cover plate, and the bracket plate is configured to form the first inlet protrusion passage and the second inlet protrusion passage with the cover plate.

8. The battery pack of claim 7, wherein the bracket plate extends in the lengthwise direction of the plate protrusion area and extends in the direction crossing the lengthwise direction of the plate protrusion area.

9. The battery pack of claim 5, wherein the cover channel includes:
a cover outlet fluidically connected with the outlet pipe; and
an outlet protrusion passage fluidically connected with the cover outlet and configured to extend on the plate protrusion area in a lengthwise direction of the plate protrusion area.

10. The battery pack of claim 5, wherein the pack housing further includes:
a pair of side members configured to cover opposite sides of the battery cell;
an end member connected to the pair of side members; and
a protruding support member configured to protrude from the end member and support the plate protrusion area.

11. The battery pack of claim 10, further comprising:
a plate sealing member configured to extend along a periphery of the plate protrusion area and seal a space between the plate protrusion area and the protruding support member.

12. The battery pack of claim 10, wherein the cover channel includes a cover inlet fluidically connected with the inlet pipe and a cover outlet fluidically connected with the outlet pipe,
wherein the protruding support member includes a first fluid connection opening fluidically connected with the cover inlet and a second fluid connection opening fluidically connected with the cover outlet, and
wherein the battery pack further includes:
a first cover sealing member disposed around the first fluid connection opening to seal a space between the cover inlet and the first fluid connection opening; and
a second cover sealing member disposed around the second fluid connection opening to seal a space between the cover outlet and the second fluid connection opening.

13. The battery pack of claim 5, further comprising:
a pack cover configured to cover the cover plate and supported by the pack housing,
wherein the pack cover includes:
a cover body area coupled to the pack housing and configured to cover the plate body area; and
a cover protrusion area configured to protrude from the cover body area and cover the plate protrusion area.

14. The battery pack of claim 13, further comprising:
a busbar electrically connected to the battery cell; and
a connector electrically connected to the busbar and configured to protrude from the cover body area to an opposite side of the battery cell,
wherein the pack cover covers the connector.

15. The battery pack of claim 5, wherein the base plate includes:
a base body area configured to contact the battery cell; and
a base protrusion area configured to protrude from the base body area and cover the inlet pipe and the outlet pipe.

16. The battery pack of claim 2, wherein the inlet pipe includes:
an inlet pipe portion; and
an inlet fluid connection pipe portion configured to extend in a direction crossing the inlet pipe portion and fluidically connect the inlet pipe portion, the base inlet, and the cover inlet.

17. The battery pack of claim 16, further comprising:
an inlet sealing member disposed around the inlet fluid connection pipe portion.

18. The battery pack of claim 2, wherein the outlet pipe includes:
an outlet pipe portion; and
an outlet fluid connection pipe portion configured to extend in a direction crossing the outlet pipe portion and fluidically connect the outlet pipe portion, the base outlet, and the cover outlet.

19. The battery pack of claim 18, further comprising:
an outlet sealing member disposed around the outlet fluid connection pipe portion.

20. The battery pack of claim 1, further comprising:
a housing sealing member configured to extend along a periphery of the pack housing and seal a space between the pack housing and the cover plate.
